(19) United States
(12) Patent Application Publication
(10) Pub. No.: US 2020/0154671 A1
(43) Pub. Date: May 21, 2020

(54) PET COSTUME

(71) Applicant: Eugenia Judy Chen, San Diego, CA (US)

(72) Inventor: Eugenia Judy Chen, San Diego, CA (US)

(21) Appl. No.: 16/610,907

(22) PCT Filed: May 4, 2018
(86) PCT No.: PCT/US18/31193

§ 371 Date: Nov. 4, 2019

Related U.S. Application Data
(60) Provisional application No. 62/501,498, filed on May 4, 2017.
(60) Provisional application No. 62/518,976, filed on Jun. 13, 2017.

(51) Int. Cl. A01K 13/00

(52) U.S. Cl. CPC A01K 13/006

(57) ABSTRACT

A pet costume is provided to accommodate a pet and provide insulation for said pet. The pet costume comprises a torso portion. The torso is provided with an aperture to accommodate the torso of the pet, and the aperture is provided with a lacing system to tighten and fasten the aperture to the pet. A hood is attached to the top of the torso and accommodates the head of the pet. An aperture is provided in the hood to allow the face of the pet to access the environment. One or more sleeves are attached to the bottom of the torso and accommodate the legs of the pet.

### CROSS-REFERENCE TO RELATED APPLICATION(S)

The present application claims priority to U.S. Provisional Patent Application No. 62/501,498 filed on May 4, 2017, entitled “Pet Costume”; and U.S. Provisional Patent Application No. 62/518,976 filed on Jun. 13, 2017, entitled “Pet Costume”, the entire disclosures of which are incorporated by reference herein.

### BACKGROUND OF THE INVENTION

### Description of Related Art

Evidence of canine companions donning fashion accessories dates to ancient Egypt, when owners would provide their dogs with decorative collars. Such collars were discovered in the tombs and rest sites. Photographic evidence of dogs in costumes dates to the early 1900s, when one photographer took portraits of bulldogs in costume.

In recent decades, dog costumes seem to have gained much popularity. In fact, the first dog fashion show, named Last Bark, was held at Bryant Park, N.Y. in 2011. Increased popularity of dog costumes may be attributed the internet and pop icons, such as Paris Hilton, dressing up their dogs.

While dogs may be adorable in costumes, securing a costume onto a canine may present several difficulties. First, the securement system must be comfortable. Most dogs are like family to their owners, and they do not want buckles prodding their canine companion. Second, the method of attachment should not catch the dog's hair or fur. Zippers would not make for a good means of attachment, as they would easily get caught in the dog's hair or fur.

Third, the costume must conform to the shape of the dog's body. This means the costume must be the appropriate size and must be designed for a dog. Finally, the costume must be quickly secured to the dog. Dogs are likely to be the most uncomfortable while the costume is being placed on to them. The attachment system should be simple enough for the time to position and secure the costume onto the dog is limited. Dogs come in a variety of body types and proportions. As a result, dog costumes typically receive poor reviews for fit due to the challenging nature of accommodating varied heights, girths and body shapes.

The foregoing considerations, although specifically noted with respect to dogs, may apply to other animals as well.

Based on the foregoing, there is a need in the art for a costume which can secured quickly and comfortably to an animal, such as a dog.

### SUMMARY OF THE INVENTION

In an embodiment, a pet costume is provided. The pet costume consists of a torso section. The torso section is provided with an aperture on the first side of the costume. First and second lacing systems are provided on the ends of the aperture to fit to the pet's torso.

In an embodiment, a hood is attached to the torso section. The hood is provided with an aperture on the second side of the costume. Two sleeves are attached to the torso section. The pet costume accommodates and provides insulation for the pet.

The foregoing, and other features and advantages of the invention, will be apparent from the following, more particular description of the embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a front perspective view of the pet costume, according to an embodiment of the present invention;

FIG. 2 is a front elevational view of the pet costume, according to an embodiment of the present invention;

FIG. 3 is a rear elevational view of the pet costume, according to an embodiment of the present invention;

FIG. 4 is a left side elevational view of the pet costume, according to an embodiment of the present invention;

FIG. 5 is a right side elevational view of the pet costume, according to an embodiment of the present invention;

FIG. 6 is a top plan view of the pet costume, according to an embodiment of the present invention;

FIG. 7 is a bottom plan view of the pet costume, according to an embodiment of the present invention;

FIG. 8 is a front perspective view of the pet costume in use, according to an embodiment of the present invention

FIG. 9 is a front perspective view of the pet costume in use, according to an embodiment of the present invention;

FIG. 10 is a front perspective view of the pet costume, according to an embodiment of the present invention; and

FIG. 11 is a detail view of the torso aperture of the pet costume, according to an embodiment of the present invention; and

FIG. 12 is a representation of the three-layer fabric of the pet costume, according to an embodiment of the present invention.

### DETAILED DESCRIPTION OF EMBODIMENTS

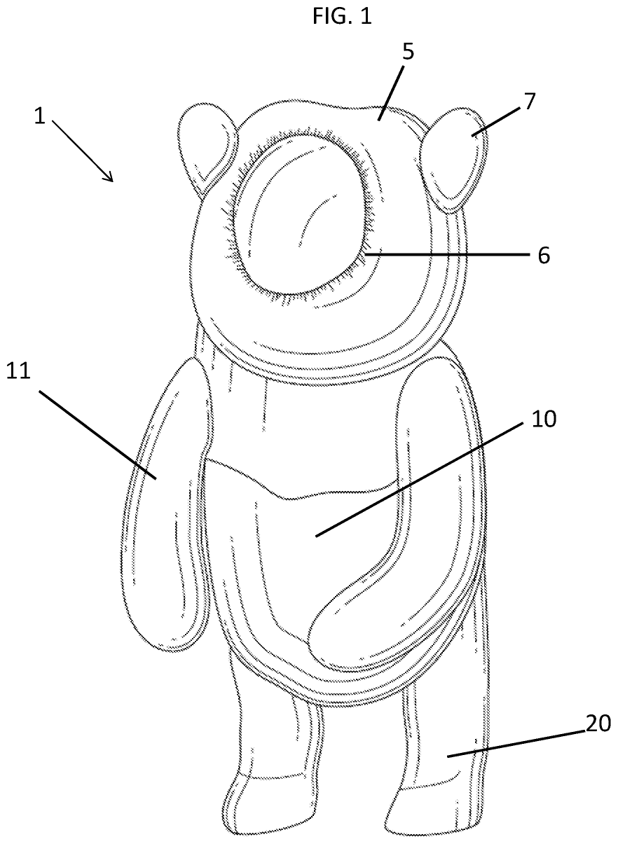

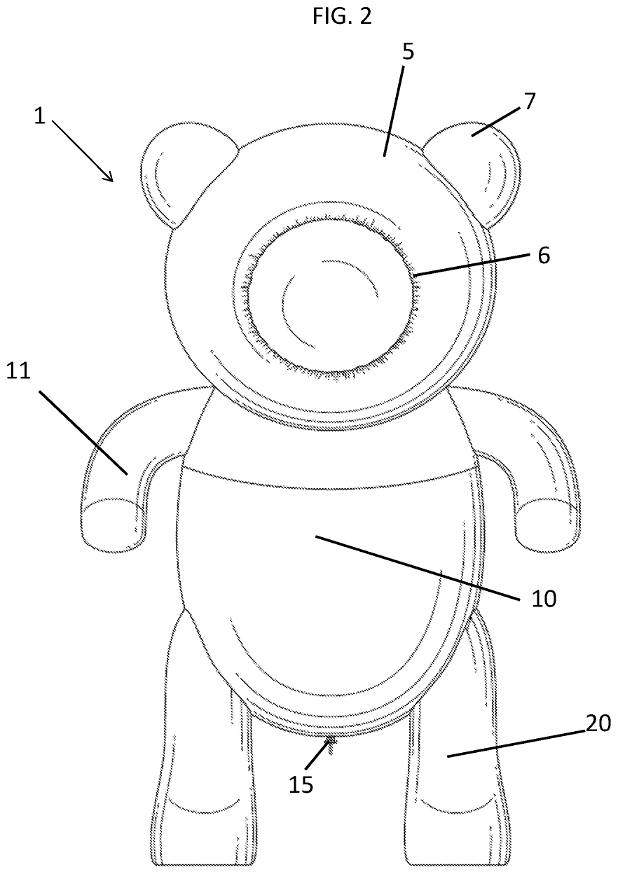

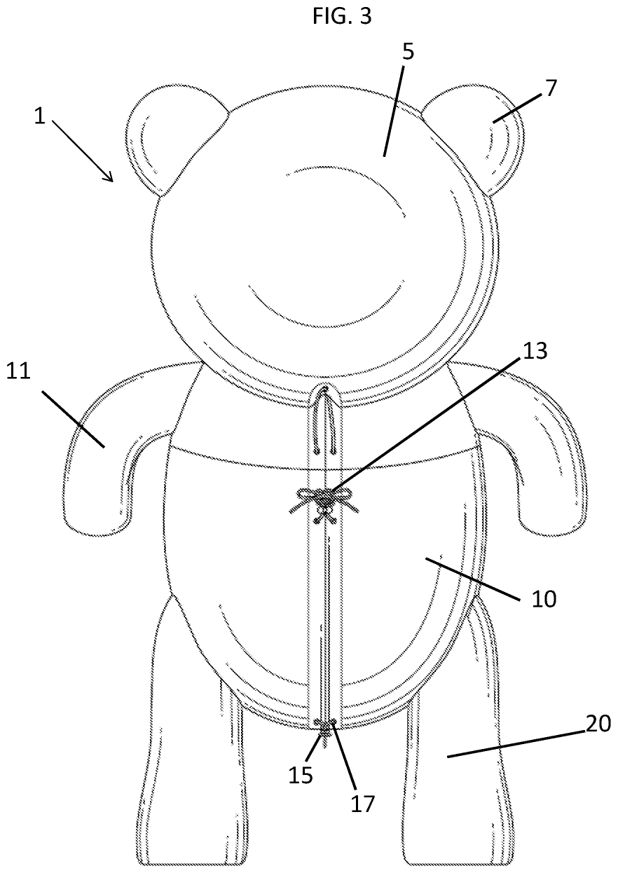

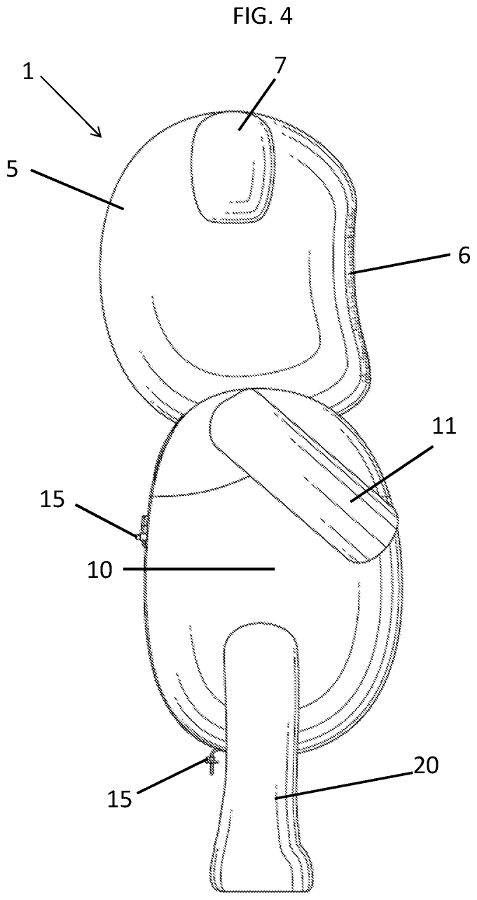

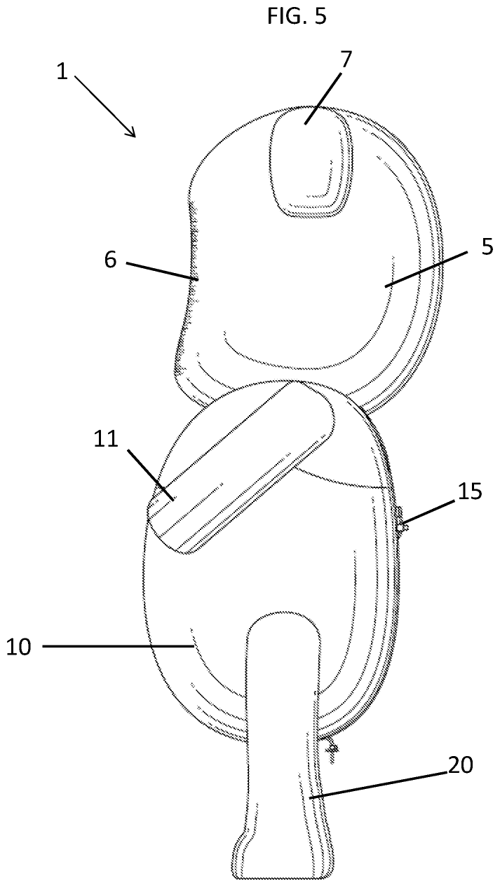

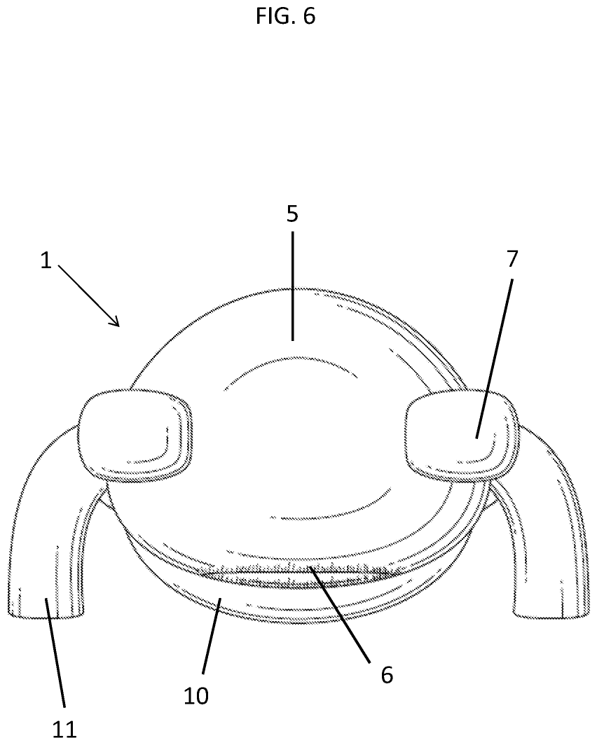

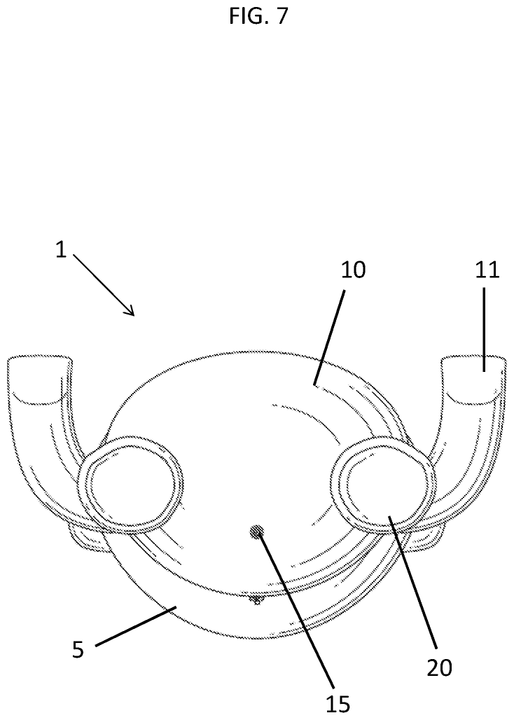

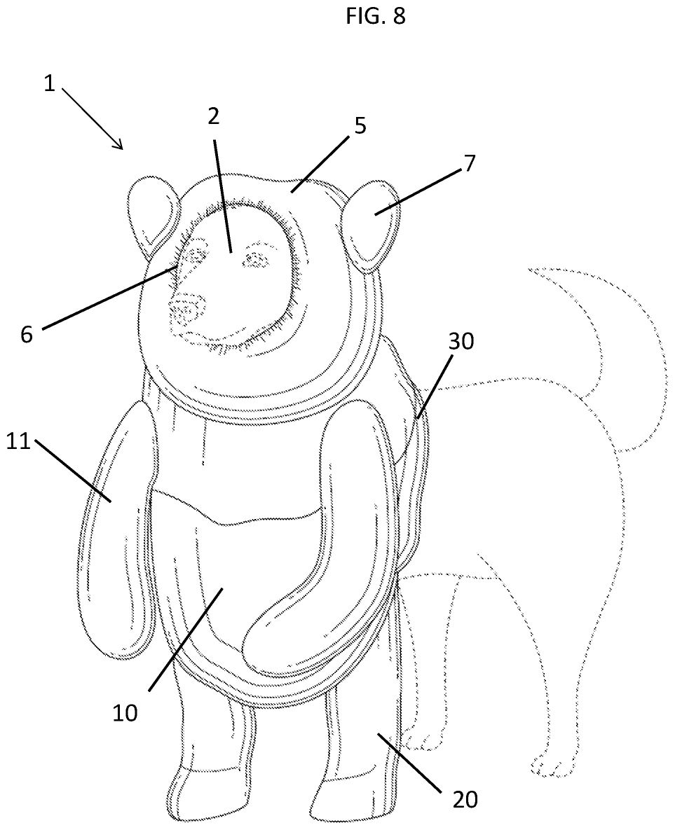

Embodiments of the present invention and their advantages may be understood by referring to FIGS. 1-12, wherein like reference numerals refer to like elements.

A costume for a domestic pet, preferably a canine, is presented herein but embodiments of the costume may also be used for other domestic animals, such as cats, ferrets, guinea pigs, rabbits and the like.

In reference to FIGS. 1-11, an embodiment of the canine costume 1 is shown being worn by a dog 2. In the embodiment shown, the costume is of the appearance of a panda bear. In other embodiment, the costume may have the appearance of other animals, creatures, or characters, which may be fictional or non-fictional.

In an embodiment, the costume is further comprised of a hood 5, which wraps around the head of the dog. Hood 5, not only adds to the appearance of the costume, but also provides insulation around the dog's head which provides additional warmth in colder weather. In the embodiment shown, the hood 5 is further comprised of an elastic band 6 for better securement on the dog's head. The hood may optionally include stuffed ears 7 to add further effect to the costume. In other embodiments, hood 5 may have ear slits for the dog's ears to pass through. Hood 5 may also be fitted with more adornments for costume effect such as horns or antlers. In other embodiments of the canine costume, there may be no hood present.

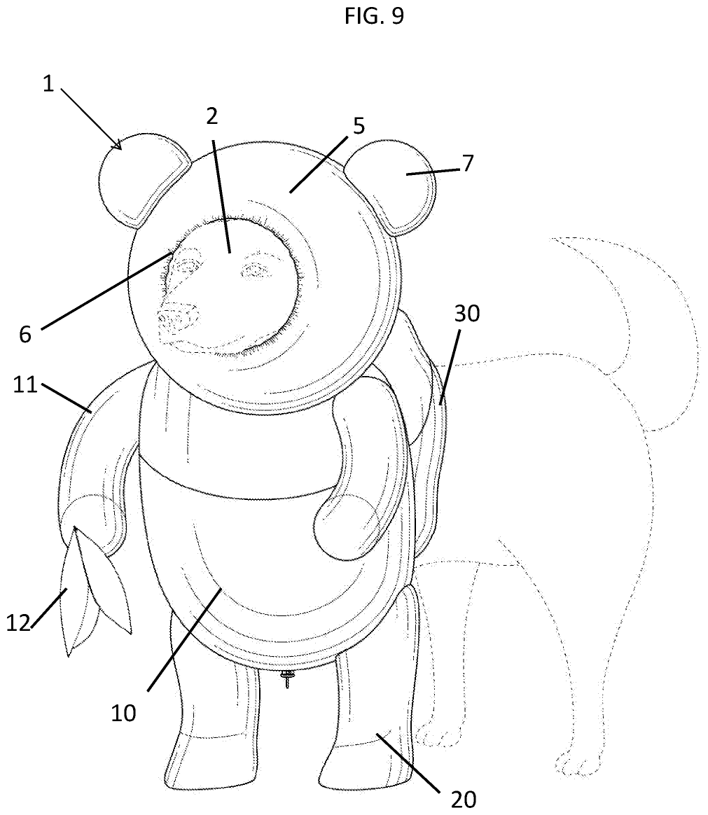

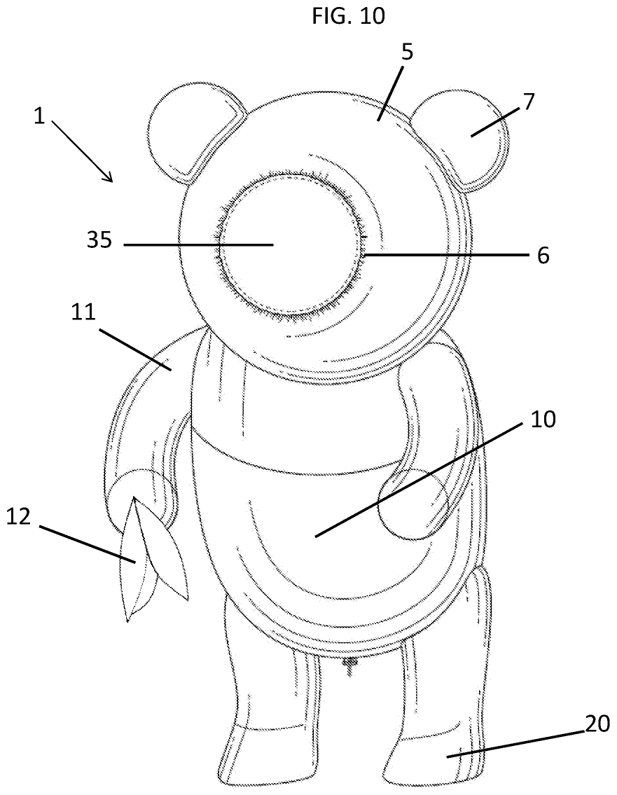

In another embodiment, the canine costume is further provided with a torso portion 10 for engaging the prosternum of a dog. In the embodiment shown, the torso portion 10 is further provided with two stuffed arms 11. One of the arms is further provided with an accessory 12 (shown in FIGS. 9-10) attached to the arm. In the embodiment shown, the accessory 12 is multiple pieces of fabric attached to the arm to appear as bamboo leaves. In other embodiments, stuffed arms may be absent from the costume, or the arms may be made to appear as other appendages, such as tentacles or claws.

In a further embodiment, the rear of torso portion is provided with a lacing securement system. The lacing securement system is comprised of a lace which releasably anchored at multiple points on opposite ends of the costume. The anchor points may be through holes in the fabric or loops attached to the costume fabric. The ends of the lace are then passed through a cinch such that the movement of the cinch towards the body of the dog tightens the costume onto the dog. In an embodiment, a single lace is used to fasten the costume onto the pet. In other embodiments, the lace may be a rope, strap, or elastic band. The lacing allows for an adjustable head girth, collar girth, chest girth, and leg length.

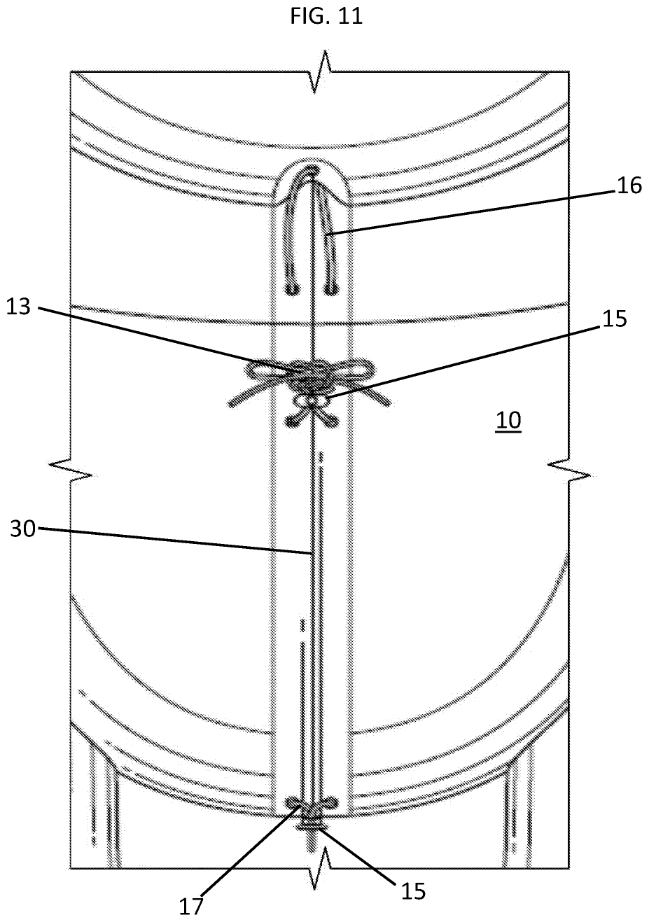

In an example embodiment, the lacing system may be comprised of two or more separate laces or cords to maximize adjustability. By providing two or more separate laces, the fit of the costume can be better adjusted to different portions of the dog's body. For example, in FIG. 11, the upper lace 16 is provided to adjust the fit of the costume upon the dog's head and torso, while lower lace 17 can adjust the fit on the dog's front legs. The separate lacing system allows for the leg length of the costume to be adjusted by approximately two inches. In an embodiment, a cinch 15 is provided on the end of the laces. In another embodiment, the laces are tied in a bow 13, eliminating the problem of excess while the costume is being worn by the dog.

In an embodiment, the canine costume is further comprised of two leg sleeves 20 extending down from torso portion 10. As shown, the legs sleeves 20 are adapted to receive the canine's legs, furthermore the legs are provided with openings on the bottom such that the dog's legs may pass through. In an embodiment, the leg sleeves may be closed on the bottom. In other embodiments, the leg sleeves may be adorned with additional decorations or accessories, the length of the leg sleeves may also be shortened, or, in another embodiment, no leg sleeves may be provided at all.

In an embodiment, a torso aperture 30 is provided to receive the torso of an animal 2. The torso aperture is adjusted by the upper lace 16 and the lower lace 17, which lace the upper and lower portions, respectively, of the torso aperture. In an embodiment, each of laces are provided with a clinch 15. A head aperture 35 is provided to accommodate the animal's face. The head aperture is provided with an elastic band 6 to provide a fit onto the animal's face. In an embodiment, the upper lace 16 also adjusts the fit of the hood 5 onto the animal's head.

In an embodiment, the costume is provided not only to dress up a pet, but also to provide warmth in cold weather. In an embodiment, the thickness of the material used for the costume may be increased to provide more insulation and warmth for colder weather. Materials known to provide added insulation maybe used in the costume such as fleece, wool, down, neoprene, and other insulator fabrics.

In another embodiment, the thickness of the material used for the costume may be decreased to provide less insulation and more breathability for warmer weather. The material may be provided with ventilation or areas in which less fabric is used to increase breathability, so the pet will not overheat due to the costume.

In another embodiment, the material used for the costume may be waterproofed to aid in keeping the pet dry in rain or when near water. The material may be natural or synthetic and coated with a waterproofing material such as rubber, polyvinyl chloride, polyurethane, silicone elastomer, fluoropolymers, wax, or other waterproofing materials.

In an embodiment, the material used for the costume may be impregnated or integrated with flea, tick, and other parasite and vector protection chemicals and substances. Examples of vector protection chemicals and substances may include, but are not limited to, synthetic chemicals such as: methoprene, tetrachlorvinphos, flumethrin, imidacloprid, and natural substances such as: pennyroyal, eucalyptus, cedarwood, citronella, rue, and amitraz.

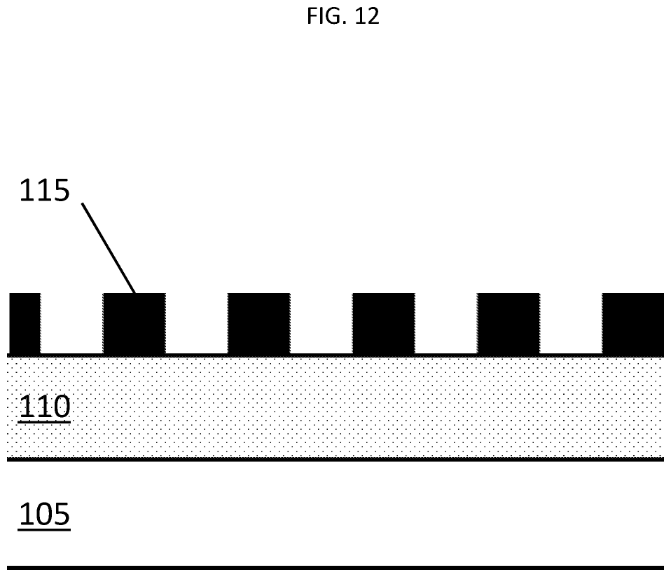

In another embodiment, the costume provides a surface on which vector, parasite, and pest protection and repellant may be applied to. In the embodiment, the costume reduces the risk of chemical toxins or irritants from the repellants coming in contact with the pet's skin. This prevents problematic skin irritation or absorption into the pet's bloodstream. In an embodiment, with reference to FIG. 12, the costume comprises at least three layers. A first, inner layer 105, contacts the pet and comprises an insulated and/or impermeable material. A second, middle layer 110, comprises a chemical or substance to provide pest control. A third, outer layer 115, comprises a permeable material to allow the pest control substances to permeate to the environment. In an embodiment, while the third layer allows partial permeation of the pest control substance, it also prevents over exposure of the pest control substance to the pet or a person who contacts outside of the costume.

The invention has been described herein using specific embodiments for the purposes of illustration only. It will be readily apparent to one of ordinary skill in the art, however, that the principles of the invention can be embodied in other ways. For instance, although the many of the embodiments of the invention presented above have been described in relation to use with a dog, use with other animals is contemplated. Therefore, the invention should not be regarded as being limited in scope to the specific embodiments disclosed herein.

I claim:

1. A pet costume having:
a torso section having a torso aperture provided on a rear side of the torso section;
an upper lacing system to lace a top portion of the torso aperture;
a lower lace system to lace a bottom portion of the torso aperture;
a hood attached to a top side of the torso section, the hood having a hood aperture provided on a front side of the hood; and
two sleeves attached to the bottom of the torso section;
wherein the costume provides insulation for a pet.

2. The pet costume of claim 1, wherein a bottom side of each of the two sleeves is further provided with an aperture.

3. The pet costume of claim 1, wherein the upper lacing system is further provided with an upper cinch, and wherein the lower lacing system is further provided with a lower cinch.

4. The pet costume of claim 3, wherein the costume is comprised a material impregnated with flea and tick prevention chemicals.

5. The pet costume of claim 3, wherein the costume is comprised of a waterproof material.

6. The pet costume of claim 4, wherein the flea and tick prevention chemicals are selected from a group consisting of methoprene, tetrachlorvinphos, flumethrin, imidacloprid, or a combination thereof.

7. The pet costume of claim 4, wherein the flea and tick prevention chemicals are selected from a group consisting of pennyroyal, eucalyptus, cedarwood, citronella, rue, amitraz, or a combination thereof.

8. The pet costume of claim 4, wherein the material impregnated with flea and tick prevention chemicals is further comprised of a first layer, the first layer being impermeable; a second layer, the second layer comprising the flea and tick prevention chemicals; and a third layer, the third layer being partially permeable.

9. The pet costume of claim 8, wherein the flea and tick prevention chemicals are selected from a group consisting of pennyroyal, eucalyptus, cedarwood, citronella, rue, amitraz, or a combination thereof.

10. The pet costume of claim 8, wherein the material impregnated with flea and tick prevention chemicals is further comprised of a first layer, the first layer being impermeable; a second layer, the second layer comprising the flea and tick prevention chemicals; and a third layer, the third layer being partially permeable.

11. A pet costume having:
a torso section having a torso aperture, the torso aperture provided on a first side of the pet costume;
a first lacing system to lace a first end portion of the torso aperture;
a second lace system to lace a second end of the torso aperture, the second end being of the torso aperture being opposite to the first end of the torso aperture;
a hood attached to the torso section, the hood having a hood aperture provided on a second side of the pet costume, the second side of the costume being opposite to the first side of the pet costume; and
two sleeves attached to the torso section;
wherein the costume provides insulation for a pet.

12. The pet costume of claim 11, wherein a perimeter of the hood aperture is provided with an elastic band.

13. The pet costume of claim 11, wherein a bottom side of each of the two sleeves is further provided with an aperture.

14. The pet costume of claim 11, wherein the first lacing system is further provided with first cinch, and wherein the second lacing system is further provided with a second cinch.

15. The pet costume of claim 11, wherein the costume is comprised a material impregnated with flea and tick prevention chemicals.

16. The pet costume of claim 11, wherein the costume is comprised of a waterproof material.

17. The pet costume of claim 15, wherein the flea and tick prevention chemicals are selected from a group consisting of methoprene, tetrachlorvinphos, flumethrin, imidacloprid, or a combination thereof.

18. The pet costume of claim 15, wherein the flea and tick prevention chemicals are selected from a group consisting of pennyroyal, eucalyptus, cedarwood, citronella, rue, amitraz, or a combination thereof.

19. The pet costume of claim 15, wherein the material impregnated with flea and tick prevention chemicals is further comprised of a first layer, the first layer being impermeable; a second layer, the second layer comprising the flea and tick prevention chemicals; and a third layer, the third layer being partially permeable.

20. The pet costume of claim 19, wherein the flea and tick prevention chemicals are selected from a group consisting of pennyroyal, eucalyptus, cedarwood, citronella, rue, amitraz, or a combination thereof.

21. The pet costume of claim 19, wherein the material impregnated with flea and tick prevention chemicals is further comprised of a first layer, the first layer being impermeable; a second layer, the second layer comprising the flea and tick prevention chemicals; and a third layer, the third layer being partially permeable.

22. The pet costume of claim 19, wherein the costume is comprised of a waterproof material.
